(19) United States
(12) Patent Application Publication
(10) Pub. No.: US 2026/0108901 A1
(43) Pub. Date: Apr. 23, 2026

(54) PRESSING PUMP CAPABLE OF PREVENTING PRESSING HEAD FROM BEING ROTATIONALLY OPENED

(71) Applicant: ZHONGSHAN LUENCHEONG DISPENSING PUMP LTD., Zhongshan (CN)

(72) Inventors: Hengjin MO, Zhongshan (CN); Tianrong LUO, Zhongshan (CN)

(21) Appl. No.: 19/414,409

(22) Filed: Dec. 10, 2025

Related U.S. Application Data
(63) Continuation of application No. PCT/CN2023/124744, filed on Oct. 16, 2023.

(30) Foreign Application Priority Data
Jul. 18, 2023 (CN) 202310887169.2

(51) Int. Cl. B05B 11/10

(52) U.S. Cl. CPC B05B 11/106

(57) ABSTRACT

The invention discloses a pressing pump capable of preventing a pressing head from being rotationally opened, comprising: a body, wherein a floating member capable of moving up and down relative to the body is disposed within the body, the floating member has a first height position and a second height position relative to the body; a pump core assembly, movably provided on the floating member, wherein an upper end of the pump core assembly is connected to the pressing head extending out of the body; an elastic member, provided between the floating member and the pressing head and used for driving the pressing head to extend upward; a linkage locking mechanism, provided between the body and the floating member and capable of stabilizing the floating member at the first height position to prevent the pressing head from moving downward, to enable the pressing head to move up and down.

### CROSS-REFERENCE TO RELATED APPLICATIONS

This application is a continuation of PCT/CN2023/124744, filed on October 16, 2023, and claims priority of Chinese Patent Application No. 202310887169.2, filed on July 18, 2023, the entire contents of which are incorporated herein by reference.

### TECHNICAL FIELD

The present invention relates to a pressing pump capable of preventing a pressing head from being rotationally opened.

### BACKGROUND

Currently, a general pressing pump comprises a body, a locking cover provided at an upper end of the body, a pressing head connected to the locking cover in a threaded mode, and a screw cover sleeved outside the body and located below the locking cover. The pressing head has a screwed-in state and a screwed-out state relative to the locking cover. In the screwed-in state, the pressing head cannot move up and down, thereby avoiding liquid overflow caused in a transportation or storage process. In the screwed-out state, the pressing head can move up and down for normal use by users.

However, during the transportation process of the pressing pump, the pressing head is prone to rotation due to collision, and the pressing head after rotating at a certain angle is prone to being separated from the locking cover, thereby causing liquid to be squeezed out when the pressing head is pressed. Moreover, in order to achieve the reciprocating up and down movement of the pressing head, a spring member is generally provided between the pressing head and the locking cover, and when the pressing head is in the screwed-in state, the spring member is in a compressed state for a long time, resulting in insufficient resilience when the pressing pump works normally, which affects the user experience.

### SUMMARY

The present invention aims to solve at least one of the technical problems existing in the prior art. For this reason, the present invention provides a pressing pump capable of preventing a pressing head from being rotationally opened, wherein the pressing head of the pressing pump cannot rise relative to a locking cover when rotating, thereby avoiding enabling a liquid discharge function of the pressing pump by accidentally touching the pressing head during a transportation process.

A pressing pump capable of preventing a pressing head from being rotationally opened according to an embodiment of the present invention comprises: a body, wherein a floating member capable of moving up and down relative to the body is disposed within the body, and the floating member has a first height position and a second height position relative to the body; a pump core assembly, movably provided on the floating member, wherein an upper end of the pump core assembly is connected to the pressing head extending out of the body; an elastic member, provided between the floating member and the pressing head and used for driving the pressing head to extend upward; and a linkage locking mechanism, provided between the body and the floating member and capable of stabilizing the floating member at the first height position to prevent the pressing head from moving downward, or stabilizing the floating member at the second height position to enable the pressing head to move up and down.

The pressing pump capable of preventing a pressing head from being rotationally opened according to the embodiment of the present invention at least has the following beneficial effects: when the pressing pump is transported or stored, the floating member is located at the first height position, at this time, the pressing head can only idle relative to the body and the floating member when rotated by an external force, and the pressing head does not have a stroke position for downward movement when pressed, thereby avoiding liquid overflow; and when it is necessary to enable a liquid discharge function of the pressing pump, the linkage locking mechanism is used to drive the floating member to switch to the second height position, the pump core assembly and the pressing head move upward by a certain distance together with the floating member, and at this time, the pressing head can move downward relative to the floating member and the body to achieve liquid discharge.

In some embodiments of the present invention, the linkage locking mechanism comprises perforated guide grooves provided on the body, guide portions provided on the floating member, and rotating members rotationally provided outside the body, the perforated guide groove comprises a spiral ascending groove spirally ascending around a central axis of the body, a first positioning groove connected to a lower end of the spiral ascending groove in an intersected mode, and a second positioning groove connected to an upper end of the spiral ascending groove in an intersected mode, the rotating member is provided with a vertical guide groove, the guide portion sequentially penetrates through the perforated guide groove and the vertical guide groove, and when the rotating member rotates relative to the body, a side wall of the vertical guide groove abuts against the guide portion to drive the guide portion to move among the first positioning groove, the spiral ascending groove, and the second positioning groove.

In some embodiments of the present invention, an installation inlet communicated with both the upper end of the spiral ascending groove and the second positioning groove is provided at an upper end edge of the body, and the installation inlet is used for allowing the guide portion to enter the perforated guide groove.

In some embodiments of the present invention, the first positioning groove is circumferentially disposed around the body, and the second positioning groove is circumferentially disposed around the body and obliquely downward.

In some embodiments of the present invention, a circle of annular sleeve is disposed at an interval on an outer peripheral wall of the body, an annular sunken groove is defined between the annular sleeve and the outer peripheral wall of the body, the rotating member comprises a circular ring sleeve located within the annular sunken groove, the vertical guide groove is provided on a side wall of the circular ring sleeve, the perforated guide groove is provided on the outer peripheral wall of the body, the floating member is capable of rotating relative to the body, and the guide portion is provided on an outer peripheral wall of the floating member to sequentially pass through the perforated guide groove and the vertical guide groove.

In some embodiments of the present invention, an upper end of the annular sleeve is provided with a circle of outwardly folded first annular flange, the rotating member further comprises a screw cap connected to an outer periphery of an upper end of the circular ring sleeve, the screw cap is provided with a second annular flange folded inward to abut against the first annular flange, and the second annular flange cooperates with the first annular flange to enable the rotating member to only rotate relative to the body.

In some embodiments of the present invention, the floating member is a sleeve capable of rotating and moving up and down inside the body, the pump core assembly penetrates through the sleeve, an outer peripheral wall of the sleeve is provided with a plurality of the guide portions circumferentially disposed around the central axis of the body, the perforated guide grooves and the vertical guide grooves are consistent with the guide portions in number, and the guide portions, the perforated guide grooves, and the vertical guide grooves are correspondingly disposed in a one-to-one mode.

In some embodiments of the present invention, a circle of annular plate is provided inside the sleeve, the pump core assembly passes upward through a middle portion of the annular plate, and the elastic member is a plastic spring with both ends respectively abutting against the annular plate and the pressing head.

In some embodiments of the present invention, the guide portion is a column disposed along the outer peripheral wall of the sleeve in a protruded mode, the guide portion, the sleeve, and the annular plate are of an integral plastic structure, and the pump core assembly, the pressing head, the body, and the rotating member are all made of a plastic material.

In some embodiments of the present invention, when the floating member is located at the first height position or the second height position, the elastic member is in an extended state.

Additional aspects and advantages of the present invention will be given in part in the following descriptions, and become apparent in part from the following descriptions, or be learned from the practice of the embodiments of the present invention.

### BRIEF DESCRIPTION OF THE DRAWINGS

The above and/or additional aspects and advantages of the present invention will become apparent and more readily appreciated from the following descriptions made with reference to the following drawings, in which:

FIG. 1 is an internal cross-sectional schematic diagram of a floating member of a pressing pump located at a second height position in an embodiment of the present invention;

FIG. 2 is a structural schematic diagram of the floating member located at a first height position in the embodiment in FIG. 1;

FIG. 3 is an exploded structural schematic diagram of the pressing pump in an embodiment of the present invention;

FIG. 4 is an internal cross-sectional schematic diagram of a body in an embodiment.

### DESCRIPTION OF EMBODIMENTS

The embodiments of the present invention are described in detail below, and examples of the embodiments are illustrated in the drawings, in which same or similar reference numerals throughout represent same or similar elements or elements with same or similar functions. The embodiments described below with reference to the drawings are exemplary, which are only used to explain the present invention and cannot be understood as limiting the present invention.

In the description of the present invention, it should be understood that orientation descriptions, for example, orientation or position relationships indicated by terms such as “upper”, “lower”, “front”, “rear”, “left”, “right”, “vertical”, “horizontal”, “top”, “bottom”, “inside”, “outside”, etc., are based on the orientation or position relationships shown in the accompanying drawings and are only to facilitate the description of the present invention and simplify the description, rather than indicating or implying that a device or element referred to must have a specific orientation or be constructed and operated in a specific orientation, and therefore cannot be understood as a limitation to the present invention.

In the description of the present invention, "several" means one or more, "a plurality of" means two or more, "greater than", "smaller than", "more than", etc. are understood as excluding the number itself, and "above", "below", "within", etc. are understood as including the number itself. "First", "second", etc., if described, are for the purpose of distinguishing technical features only, but should not be understood as indicating or implying a relative importance or implicitly indicating the number of technical features indicated or implicitly indicating the precedence of technical features indicated.

In the description of the present invention, it should be noted that, unless otherwise clearly stated and limited, terms such as “install”, “connect”, and “connection” should be understood in a broad sense, for example, may be fixed connection, and may also be detachable connection, or integral connection; may be mechanical connection, and may also be electrical connection; and may be direct connection, and may also be indirect connection through an intermediate medium, or internal communication between two elements. For persons of ordinary skill in the art, specific meanings of the above terms in the present invention may be understood according to specific circumstances.

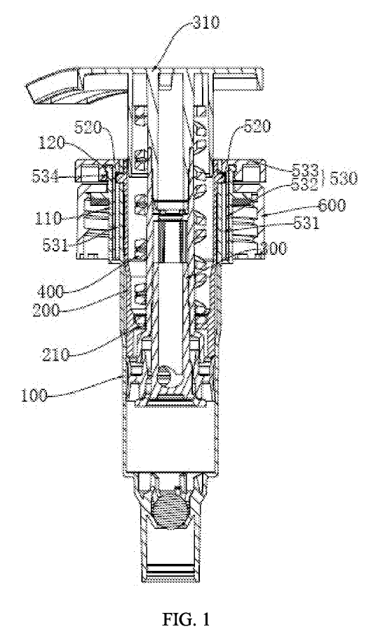

Referring to FIG. 1 to FIG. 4, a pressing pump capable of preventing a pressing head from being rotationally opened of the present invention comprises: a body 100, wherein a floating member 200 capable of moving up and down relative to the body is disposed within the body 100, and the floating member 200 has a first height position and a second height position relative to the body 100; a pump core assembly 300, movably provided on the floating member 200, wherein an upper end of the pump core assembly 300 is connected to the pressing head 310 extending out of the body 100; an elastic member 400, provided between the floating member 200 and the pressing head 310 and used for driving the pressing head 310 to extend upward; and a linkage locking mechanism, provided between the body 100 and the floating member 200 and capable of stabilizing the floating member 200 at the first height position to prevent the pressing head 310 from moving downward, or stabilizing the floating member 200 at the second height position to enable the pressing head 310 to move up and down.

When the pressing pump is transported or stored, the floating member 200 is located at the first height position, at this time, the pressing head 310 can only idle relative to the body 100 and the floating member 200 when rotated by an external force, and the pressing head 310 does not have a stroke position for downward movement when pressed, thereby avoiding liquid overflow; and when it is necessary to enable a liquid discharge function of the pressing pump, the linkage locking mechanism is used to drive the floating member 200 to switch to the second height position, the pump core assembly 300 and the pressing head 310 move upward by a certain distance together with the floating member 200, and at this time, the pressing head 310 can move downward relative to the floating member 200 and the body 100 to achieve liquid discharge.

Referring to FIG. 1 to FIG. 4, in some embodiments of the present invention, the linkage locking mechanism comprises perforated guide grooves 510 provided on the body 100, guide portions 520 provided on the floating member 200, and rotating members 530 rotationally provided outside the body 100, the perforated guide groove 510 comprises a spiral ascending groove 511 spirally ascending around a central axis of the body 100, a first positioning groove 512 connected to a lower end of the spiral ascending groove 511 in an intersected mode, and a second positioning groove 513 connected to an upper end of the spiral ascending groove 511 in an intersected mode, the rotating member 530 is provided with a vertical guide groove 531, the guide portion 520 sequentially penetrates through the perforated guide groove 510 and the vertical guide groove 531, and when the rotating member 530 rotates relative to the body 100, a side wall of the vertical guide groove 531 abuts against the guide portion 520 to drive the guide portion 520 to move among the first positioning groove 512, the spiral ascending groove 511, and the second positioning groove 513. It should be noted that when the pressing pump is transported or stored and when the floating member 200 is located at the first height position, the pressing head 310 abuts against the upper end of the body 100 or a height gap between the pressing head 310 and the body 100 is very small, which is insufficient to achieve liquid discharge by pressing the pressing head 310, and at this time, the guide portion 520 is located in the first positioning groove 512 and located at a lower portion of the vertical guide groove 531; then, when a user rotates the rotating member 530, the vertical guide groove 531 drives the guide portion 520 to leave from the first positioning groove 512 and enter the spiral ascending groove 511; as the rotating member 530 continuously rotates, the guide portion 520 gradually moves from the lower end of the spiral ascending groove 511 to the upper end of the spiral ascending groove 511 and then enters the second positioning groove 513, and the guide portion 520 also moves from the lower portion of the vertical guide groove 531 to an upper portion of the vertical guide groove 531; and meanwhile, the floating member 200 rotates and rises to switch to the second height position, and the pressing head 310 can move downward relative to the body 100.

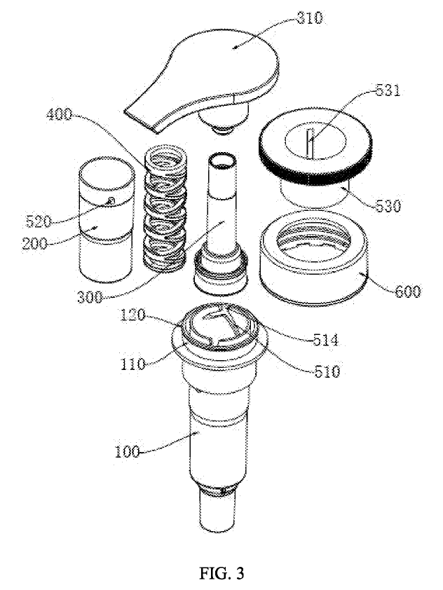

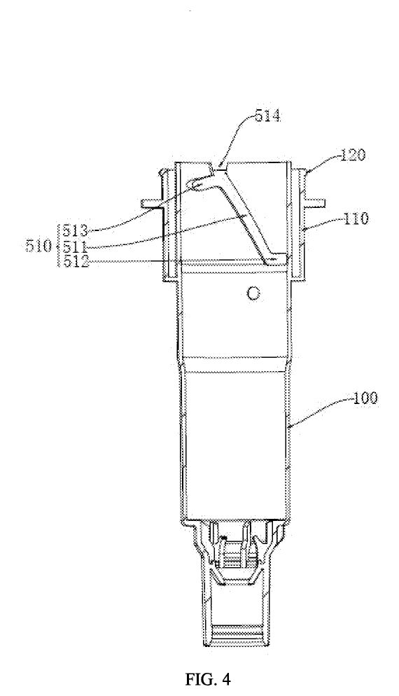

Referring to FIG. 3 and FIG. 4, in some embodiments of the present invention, an installation inlet 514 communicated with both the upper end of the spiral ascending groove 511 and the second positioning groove 513 is provided at an upper end edge of the body 100, and the installation inlet 514 is used for allowing the guide portion 520 to enter the perforated guide groove 510. It should be noted that during assembly, the floating member 200 is inserted into the body 100, the guide portion 520 on the floating member 200 is aligned with the installation inlet 514 and inserted, and the vertical guide groove 531 of the rotating member 530 is aligned with the guide portion 520 to enable the guide groove to be embedded, so that the above structure is favorable for assembly of the pressing pump.

Referring to FIG. 4, in some embodiments of the present invention, the first positioning groove 512 is circumferentially disposed around the body 100, and the second positioning groove 513 is circumferentially disposed around the body 100 and obliquely downward. It may be understood that when the rotating member 530 rotates at a relatively small angle, the guide portion 520 moves in the first positioning groove 512 and does not enter the spiral ascending groove 511, and at this time, the floating member 200 is always located at the first height position to prevent the pressing pump from easily enabling the liquid discharge function; and when the guide portion 520 enters the second positioning groove 513, since the second positioning groove 513 is circumferentially disposed around the body 100 and obliquely downward, when the pressing head 310 is pressed downward, the guide portion 520 will not re-enter the spiral ascending groove 511 due to slight deflection of the floating member 200, thereby ensuring normal pressing operation of the pressing pump.

Referring to FIG. 1 and FIG. 4, in some embodiments of the present invention, a circle of annular sleeve 110 is disposed at an interval on an outer peripheral wall of the body 100, an annular sunken groove is defined between the annular sleeve 110 and the outer peripheral wall of the body 100, the rotating member 530 comprises a circular ring sleeve 532 located within the annular sunken groove, the vertical guide groove 531 is provided on a side wall of the circular ring sleeve 532, the perforated guide groove 510 is provided on the outer peripheral wall of the body 100, the floating member 200 is capable of rotating relative to the body 100, and the guide portion 520 is provided on an outer peripheral wall of the floating member 200 to sequentially pass through the perforated guide groove 510 and the vertical guide groove 531. It may be understood that the annular sunken groove plays a rotation guide role for the circular ring sleeve 532, thereby achieving rotation of the rotating member 530 relative to the body 100. Moreover, the pressing pump with the above structure is simple in structure, convenient to produce, and also favorable for improving structural compactness. A locking cover 600 for connecting a bottle body is also rotationally provided outside the annular sleeve 110.

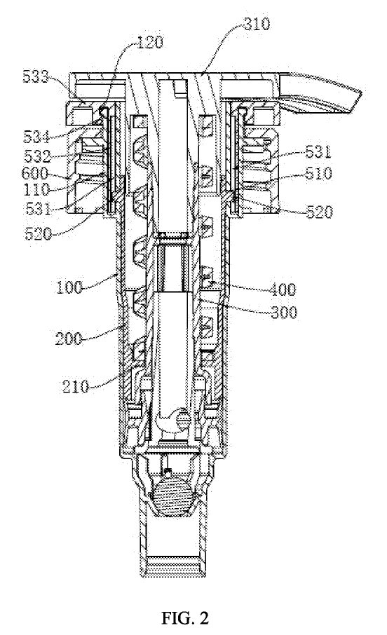

Referring to FIG. 1 and FIG. 2, in some embodiments of the present invention, an upper end of the annular sleeve 110 is provided with a circle of outwardly folded first annular flange 120, the rotating member 530 further comprises a screw cap 533 connected to an outer periphery of an upper end of the circular ring sleeve 532, the screw cap 533 is provided with a second annular flange 534 folded inward to abut against the first annular flange 120, and the second annular flange 534 cooperates with the first annular flange 120 to enable the rotating member 530 to only rotate relative to the body 100. The second annular flange 534 extends and is disposed downward along a lower surface of the screw cap 533, and the second annular flange 534 hooks the first annular flange 120 to prevent the rotating member 530 from detaching upward relative to the body 100.

Referring to FIG. 2 and FIG. 3, in some embodiments of the present invention, in order to improve the operational reliability of the linkage locking mechanism and also make the relative movement among the rotating member 530, the floating member 200 and the body 100 stabler, the floating member 200 is a sleeve capable of rotating and moving up and down inside the body 100, the pump core assembly 300 penetrates through the sleeve, an outer peripheral wall of the sleeve is provided with a plurality of the guide portions 520 circumferentially disposed around the central axis of the body 100, the perforated guide grooves 510 and the vertical guide grooves 531 are consistent with the guide portions 520 in number, and the guide portions 520, the perforated guide grooves 510, and the vertical guide grooves 531 are correspondingly disposed in a one-to-one mode. In the present embodiment, two guide portions 520, two perforated guide grooves 510, and two vertical guide grooves 531 are disposed.

Referring to FIG. 1 and FIG. 2, in some embodiments of the present invention, a circle of annular plate 210 is provided inside the sleeve, the pump core assembly 300 passes upward through a middle portion of the annular plate 210, and the elastic member 400 is a plastic spring with both ends respectively abutting against the annular plate 210 and the pressing head 310, which is favorable for reducing the cost of the pressing pump.

In some embodiments of the present invention, the guide portion 520 is a column disposed along the outer peripheral wall of the sleeve in a protruded mode, the guide portion 520, the sleeve, and the annular plate 210 are of an integral plastic structure, and the pump core assembly 300, the pressing head 310, the body 100, and the rotating member 530 are all made of a plastic material. It may be understood that all components of the pressing pump with the above structure are made of a plastic material, which reduces the difficulty of recycling, is also favorable for environmental protection, and can also reduce the cost.

Referring to FIG. 1 and FIG. 2, in some embodiments of the present invention, when the floating member 200 is located at the first height position or the second height position, the elastic member 400 is in an extended state. It should be noted that compared with traditional pressing pumps, when the pressing head 310 of the pressing pump of the present invention is in a retracted state, since the floating member 200, the pump core assembly 300, and the pressing head 310 together descend by a certain distance relative to the body 100, there is no need to compress the elastic member 400; and when the pressing head 310 is in an extended state, the floating member 200, the pump core assembly 300, and the pressing head 310 together rise by a certain distance relative to the body 100, at this time, liquid discharge can be achieved by directly pressing the pressing head 310, a service life of the elastic member 400 is ensured, and a rebound stroke of the pressing head 310 of the pressing pump is also stabler.

Various technical features of the above embodiments can be combined arbitrarily. For conciseness, not all possible combinations of various technical features in the above embodiments are described. However, as long as there is no contradiction in combinations of these technical features, they should be considered as falling within the scope of this specification.

Although the embodiments of the present invention are shown and described, it may be understood by those of ordinary skill in the art that various changes, modifications, substitutions and alternations of the embodiments may be made without departing from the principles and spirit of the present invention, and the scope of the present invention is defined by the claims and equivalents thereof.

What is claimed is:

1. A pressing pump capable of preventing a pressing head from being rotationally opened, comprising:
a body, wherein a floating member capable of moving up and down relative to the body is disposed within the body, and the floating member has a first height position and a second height position relative to the body;
a pump core assembly, movably provided on the floating member, wherein an upper end of the pump core assembly is connected to the pressing head extending out of the body;
an elastic member, provided between the floating member and the pressing head and used for driving the pressing head to extend upward; and
a linkage locking mechanism, provided between the body and the floating member and capable of stabilizing the floating member at the first height position to prevent the pressing head from moving downward, or stabilizing the floating member at the second height position to enable the pressing head to move up and down.

2. The pressing pump capable of preventing a pressing head from being rotationally opened according to claim 1, wherein
the linkage locking mechanism comprises perforated guide grooves provided on the body, guide portions provided on the floating member, and rotating members rotationally provided outside the body, the perforated guide groove comprises a spiral ascending groove spirally ascending around a central axis of the body, a first positioning groove connected to a lower end of the spiral ascending groove in an intersected mode, and a second positioning groove connected to an upper end of the spiral ascending groove in an intersected mode, the rotating member is provided with a vertical guide groove, the guide portion sequentially penetrates through the perforated guide groove and the vertical guide groove, and when the rotating member rotates relative to the body, a side wall of the vertical guide groove abuts against the guide portion to drive the guide portion to move among the first positioning groove, the spiral ascending groove, and the second positioning groove.

3. The pressing pump capable of preventing a pressing head from being rotationally opened according to claim 2, wherein
an installation inlet communicated with both the upper end of the spiral ascending groove and the second positioning groove is provided at an upper end edge of the body, and the installation inlet is used for allowing the guide portion to enter the perforated guide groove.

4. The pressing pump capable of preventing a pressing head from being rotationally opened according to claim 2, wherein
the first positioning groove is circumferentially disposed around the body, and the second positioning groove is circumferentially disposed around the body and obliquely downward.

5. The pressing pump capable of preventing a pressing head from being rotationally opened according to claim 2, wherein
a circle of annular sleeve is disposed at an interval on an outer peripheral wall of the body, an annular sunken groove is defined between the annular sleeve and the outer peripheral wall of the body, the rotating member comprises a circular ring sleeve located within the annular sunken groove, the vertical guide groove is provided on a side wall of the circular ring sleeve, the perforated guide groove is provided on the outer peripheral wall of the body, the floating member is capable of rotating relative to the body, and the guide portion is provided on an outer peripheral wall of the floating member to sequentially pass through the perforated guide groove and the vertical guide groove.

6. The pressing pump capable of preventing a pressing head from being rotationally opened according to claim 5, wherein
an upper end of the annular sleeve is provided with a circle of outwardly folded first annular flange, the rotating member further comprises a screw cap connected to an outer periphery of an upper end of the circular ring sleeve, the screw cap is provided with a second annular flange folded inward to abut against the first annular flange, and the second annular flange cooperates with the first annular flange to enable the rotating member to only rotate relative to the body.

7. The pressing pump capable of preventing a pressing head from being rotationally opened according to claim 2, wherein
the floating member is a sleeve capable of rotating and moving up and down inside the body, the pump core assembly penetrates through the sleeve, an outer peripheral wall of the sleeve is provided with a plurality of the guide portions circumferentially disposed around the central axis of the body, the perforated guide grooves and the vertical guide grooves are consistent with the guide portions in number, and the guide portions, the perforated guide grooves, and the vertical guide grooves are correspondingly disposed in a one-to-one mode.

8. The pressing pump capable of preventing a pressing head from being rotationally opened according to claim 7, wherein
a circle of annular plate is provided inside the sleeve, the pump core assembly passes upward through a middle portion of the annular plate, and the elastic member is a plastic spring with both ends respectively abutting against the annular plate and the pressing head.

9. The pressing pump capable of preventing a pressing head from being rotationally opened according to claim 8, wherein
the guide portion is a column disposed along the outer peripheral wall of the sleeve in a protruded mode, the guide portion, the sleeve, and the annular plate are of an integral plastic structure, and the pump core assembly, the pressing head, the body, and the rotating member are all made of a plastic material.

10. The pressing pump capable of preventing a pressing head from being rotationally opened according to claim 1, wherein
when the floating member is located at the first height position or the second height position, the elastic member is in an extended state.
